(19) United States
(12) Patent Application Publication
(10) Pub. No.: US 2011/0151344 A1
(43) Pub. Date: Jun. 23, 2011

(54) METHOD OF CONTROLLING FUEL CELL SYSTEM

(75) Inventors: Jin S. Heo, Suwon-si (KR); Jung-seok Yi, Seoul (KR)

(73) Assignee: Samsung Electronics Co., Ltd., Suwon-si (KR)

(21) Appl. No.: 12/948,864

(22) Filed: Nov. 18, 2010

(30) Foreign Application Priority Data
Dec. 17, 2009 (KR) 10-2009-0126256

(51) Int. Cl. H01M 8/04; H01M 8/06

(52) U.S. Cl. 429/427; 429/430

(57) ABSTRACT

A method of controlling a fuel cell system, the method involving: controlling the power output of the fuel cell system and an amount of a fuel that is supplied to the fuel cell system, so as to increase a fuel utilization rate of a fuel cell, according to variations of the power output of the fuel cell system.

### CROSS-REFERENCE TO RELATED APPLICATION

This application claims the benefit of Korean Patent Application No. 10-2009-0126256, filed on Dec. 17, 2009 in the Korean Intellectual Property Office, the disclosure of which is incorporated herein in its entirety, by reference.

### BACKGROUND

1. Field

The present disclosure relates to a fuel cell system, and methods and apparatuses for controlling the fuel cell system.

2. Description of the Related Art

A fuel cell is an environmental-friendly replacement energy technology for generating electricity from substances that are naturally abundant, such as hydrogen. A fuel currently supplied in the market, e.g., city gas, does not have a hydrogen density generally considered sufficient to be used in a fuel cell, and thus, it is often necessary to use an apparatus to reform city gas. In this regard, research has been actively performed for developing an algorithm of a fuel cell system, so as to control the supply of a fuel, air, or the like, by the apparatus.

### SUMMARY

Provided are a fuel cell system, and methods and apparatuses for controlling the fuel cell system, so as to improve the efficiency of the fuel cell system, using existing fuel cell system hardware.

Provided is a computer readable recording medium having recorded thereon a program for executing the methods, by using a computer.

Additional aspects will be set forth in part in the description which follows and, in part, will be apparent from the description, or may be learned by practice of the presented embodiments.

According to an aspect of the present invention, a method of controlling a fuel cell system includes detecting a variation of the power output of the fuel cell system; and controlling the power output and an amount of a fuel supplied to the fuel cell system, so as to increase the fuel utilization rate of a fuel cell, according to the variation of the power output.

According to another aspect of the present invention, a computer readable recording medium includes a program recorded on the computer readable recording medium, so as to execute the method of controlling the fuel cell system, using a computer.

According to another aspect of the present invention, a fuel cell system includes a fuel cell for generating electric power using a fuel; a power converter for converting the power generated by the fuel cell into power to be supplied to a load; and a controller for controlling the power converter and the amount of fuel supplied, so as to increase the fuel utilization rate of the fuel cell, according to a variation of a power output of the power converter.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the present disclosure will become apparent and more readily appreciated from the following description of the exemplary embodiments, taken in conjunction with the accompanying drawings, of which:

FIG. 1 is a diagram of a configuration of a fuel cell system, according to an embodiment of the present invention;

FIG. 2 is a diagram of various control examples of the fuel cell system of FIG. 1; and

FIGS. 3 and 4 are flowcharts of a control method performed by a controller of FIG. 1, according to an embodiment of the present invention.

### DETAILED DESCRIPTION

Reference will now be made in detail to the exemplary embodiments of the present invention, examples of which are illustrated in the accompanying drawings, wherein like reference numerals refer to the like elements throughout. The exemplary embodiments are described below, in order to explain aspects of present invention, by referring to the figures.

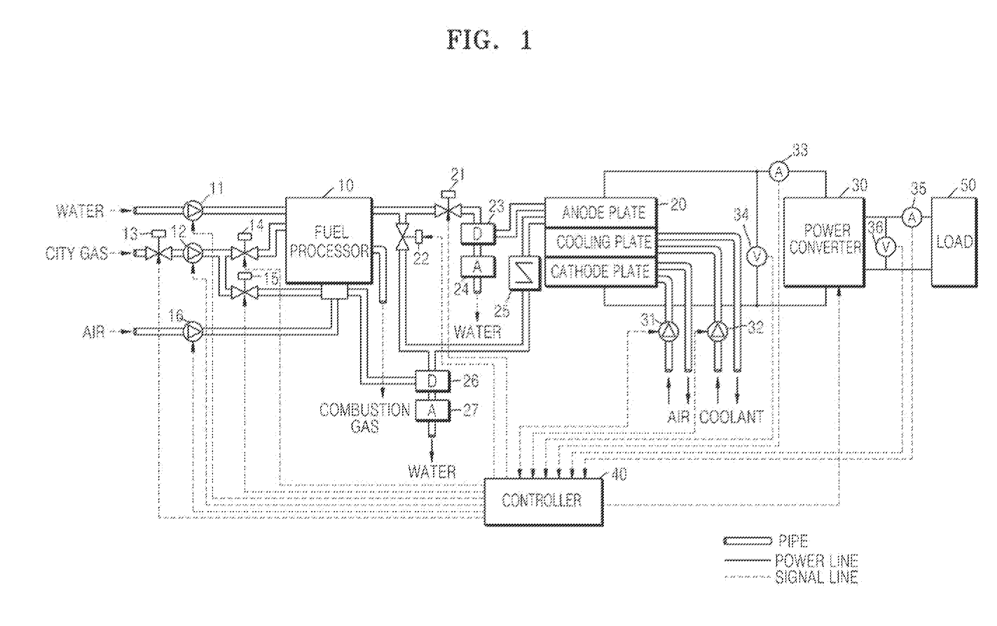

FIG. 1 is a diagram of a configuration of a fuel cell system, according to an embodiment of the present invention. Referring to FIG. 1, the fuel cell system includes a fuel processor 10, a fuel cell 20, a power converter 30, and a controller 40. The power converter 30 may be referred to as a power conditioning system (PCS).

The fuel processor 10 reacts a fuel and water, to generate a reformed gas having a hydrogen density sufficient to be used in the fuel cell 20. Examples of raw materials for the reformed gas include city gas, liquefied petroleum gas (LPG), kerosene, and the like. Currently, the city gas (such as natural gas) is most often used to generate the reformed gas, and hereinafter, the present embodiment will be described with respect to the city gas. In the fuel processor 10, the reform reaction of CH4+H₂O→CO+3H₂ occurs between the city gas and the water, and simultaneously, the shift reaction of CO+H₂O→CO₂+H2 generally occurs. With respect to the reform reaction, when a temperature of a reform catalyst used to facilitate the reform reaction is maintained at about 700° C., the hydrogen density of the reformed gas is sufficiently high. The city gas supplied to the fuel processor 10 is used in the reform reaction and is simultaneously used for a burner to heat the reform catalyst. Hereinafter, the temperature of the reform catalyst 10 may be simply referred to as a “reform temperature” of the fuel processor 10.

The fuel processor 10 is connected to a water pump 11 for supplying water to the fuel processor 10. The water supplied to the fuel processor 10 may be deionized water, in order to facilitate the reform reaction. Also, the fuel cell processor 10 is connected to a city gas pump 12 for supplying the city gas to the fuel processor 10. An electronic valve 13 for adjusting a total amount of city gas supplied to the fuel processor 10 is inserted into a front end of the city gas pump 12. An electronic valve 14 and an electronic valve 15 are disposed downstream from the pump 12. The electronic valve 14 is for adjusting an amount of city gas supplied for the reform reaction, and the electronic valve 15 is for adjusting an amount of city gas supplied to the burner used for heating the reform catalyst. Also, an air pump 16 for supplying air to the fuel processor 10, in order for the burner to combust the city gas supplied thereto, is connected to the fuel processor 10. Also, the fuel cell processor 10 is connected to an outlet for discharging the exhaust from the burner.

The fuel cell 20 generates power using the gas reformed by the fuel processor 10. In more detail, the fuel cell 20 is formed of a plurality of unit cells for directly converting a chemical energy of the reformed gas into an electric energy, using an electrochemical reaction, in which hydrogen in the reformed gas is combined with oxygen in air. The fuel cell also includes a cooling plate for cooling the unit cells. Each of the unit cells is formed of an anode plate, to which the hydrogen in the reformed gas is supplied, a proton exchange membrane for selectively transmitting protons separated from the hydrogen, and a cathode plate, to which an oxidant (oxygen in the air), is supplied.

As described above, the unit cells are stacked together in the fuel cell 20, with each unit cell generating a unit amount of power. However, for ease of description, only one unit cell, which includes the anode plate, cooling plate, and cathode plate, is illustrated in the fuel cell 20 of FIG. 1. However, it will be understood by one of ordinary skill in the art that the fuel cell 20 may be formed of a plurality of the unit cells disposed in a stack, and that the present description may be applied to each of the stacked unit cells.

Except for when the fuel cell 20 is operating at a temperature equal to or greater than about 500° C., if the reformed gas supplied to an anode inlet of the fuel cell 20 includes carbon monoxide (CO), a platinum-based electrode catalyst of the anode plate may be poisoned. That is, according to an operation temperature of the fuel cell 20, the CO tolerance of the anode plate catalyst increases, and in cases where the fuel cell 20 is operating at a temperature about 150° C., a CO concentration in the reformed gas should to be reduced to less than 0.5%. When the fuel processor 10 starts reforming the city gas (in an initial operation stage of the fuel processor 10), if the reformed gas contains a relatively high concentration of CO, the fuel cell system does not send the reformed gas to the fuel cell 20. Instead, the reformed gas discharged from the fuel processor 10 is supplied to the burner, to heat the reform catalyst, until the CO concentration in the reformed gas is reduced to less than 0.5%.

For this, a bypassing apparatus is arranged between the fuel processor 10 and the fuel cell 20, so as to selectively supply the reformed gas to the fuel cell 20, according to the CO concentration in the reformed gas. The bypassing apparatus is formed of pipes and electronic valves, for redirecting the reformed gas generated in the fuel processor 10 back to the fuel processor 10. In more detail, in cases where the CO concentration in the reformed gas is equal to or greater than 0.5%, the reformed gas generated by the fuel processor 10 is directed back to the fuel processor 10, by closing an electronic valve 21 and opening an electronic valve 22. When the CO concentration in the reformed gas generated by the fuel processor 10 is less than 0.5%, the reformed gas is supplied to the fuel cell 20, by opening the electronic valve 21 and closing the electronic valve 22.

The reformed gas discharged from the fuel processor 10 contains water. The water condenses while passing through the pipes, thereby interfering with a flow of the reformed gas within the pipes. Accordingly, a drain separator 23 for separating the water from the reformed gas flowing in the pipes, and an auto drain 24 for discharging the water separated by the drain separator 23 out of the fuel cell system, are arranged midway along a pipe between the fuel processor 10 and the fuel cell 20.

An anode off gas (AOG), including un-reacted hydrogen and water is discharged from an anode outlet of the fuel cell 20. The discharged AOG is collected by the fuel processor 10 and is then supplied to the burner to heat the reform catalyst. For this, a pipe is connected between the anode outlet of the fuel cell 20 and the fuel processor 10. A one-way check valve 25 is inserted in the pipe, so as to prevent the reformed gas from flowing from the fuel processor 10 back to the anode outlet of the fuel cell 20. The check valve 25 allows a flow in one direction but does not allow a flow in the direction opposite. It is possible to heat the reform catalyst using only the AOG. However, when the amount of AOG is insufficient to heat the reform catalyst, it is possible to heat the reform catalyst using the AOG and the city gas supplied by the city gas pump 12 through the electronic valve 15.

Since the reformed gas and the AOG contain water, a drain separator 26 for separating the water from the reformed gas and the AOG flowing in a pipe, and an auto drain 27 for discharging the water separated by the drain separator 26 out of the fuel cell system, are arranged midway along the pipe in which the reformed gas and the AOG 10 flow. Although not illustrated in FIG. 1, it will be understood by one of ordinary skill in the art that several other parts including heat exchangers for collecting heat emitted from the reformed gas discharged from the fuel processor 10, heat emitted from the AOG discharged from the fuel cell 20, and the like, may be additionally arranged in the fuel cell system of FIG. 1.

The power converter 30 converts the power generated by the fuel cell 20 into power that may be supplied to a load 50, according to the control of the controller 40. The performance of the fuel cell 20 changes according to the operating conditions and operating time thereof, and a response time of the fuel cell 20, in response to a change of the load 50, is low. The controller 40 controls the power converter 30, such that the power converter 30 outputs a voltage and a current demanded by the load 50, in consideration of the characteristics of the fuel cell 20.

An electrical efficiency of the fuel cell system of FIG. 1 is calculated by using Equation 1, below. According to Equation 1, the fuel cell system of FIG. 1 is directed to generating a constant voltage via the fuel cell 20, and a voltage output from the power converter 30 is a constant 220V. It will be understood by one of ordinary skill in the art that the fuel cell system of FIG. 1 may also be applied to a system for generating a constant current via the fuel cell 20 and a current output from the power converter 30 is constant.

$$System Elfiency = \frac{\begin{matrix}\begin{matrix}PCS current output [ {A}_{ac} ] \times \\ 220 [ {V}_{ac} ] \times 1 ( power factor ) \times \end{matrix} \\ [ \frac{{W}_{ac}}{{A}_{ac} \cdot {V}_{ac}} ] \times [ \frac{J / s}{{W}_{ac}} ]\end{matrix}}{\begin{matrix}\begin{matrix}\frac{( {F}_{BCH 4} + {F}_{RCH 4} ) [ I / min ]}{22.4 \times \frac{273.15 + {T}_{ref}}{273.15} [ I / mol ]} \times \\ 212.71 [ kcal / mol ] \times \end{matrix} \\ 4.184 [ k J / kcal ] \times \frac{1}{60 [ s \text{/} min ]}\end{matrix}} \qquad [ Equation 1 ]$$

A variable component of the numerator in Equation 1 is the power (current) output of the power converter 30. A variable component of the denominator in Equation 1 is the total amount of the city gas supplied to the fuel cell system of FIG. 1. That is, the total amount of city gas includes the city gas F_{RCH4}, reformed by the fuel processor 10 and the city gas F_{BCH4} burned by the burner. Here, T_{ref} indicates a temperature of the city gas supplied to the fuel cell system of FIG. 1, and is set to be a general room temperature, i.e., 20° C.

In order to increase an efficiency of the fuel cell system using Equation 1, the power output of the power converter 30 may be increased, or the amount of the city gas F_{RCH4} supplied to the fuel cell 20, and/or the amount of the city gas F_{BCH4} supplied to the burner, may be decreased.

In order to increase the power output of the power converter 30, with respect to the same amount of the city gas supplied to the fuel cell system, a fuel utilization rate of the fuel cell 20 may be increased. The fuel utilization rate of the fuel cell 20 is calculated using Equation 2 below. The fuel utilization rate is generally about 80%, but the fuel utilization rate may be changed, according to an amount of the reformed gas generated, according to the change of the load 50, and the operating condition of the fuel cell 20.

$${U}_{f} \text{:} \frac{\frac{i [ A ]}{n \cdot F [ C / md ]}}{{F}_{H 2} [ I / min ]} = \frac{\begin{matrix}Current Dersity [ A / {cm}^{2} ] \times \\ Area [ {cm}^{2} ] \times numberofcell \times \\ 60 [ s \text{/} min ]\end{matrix}}{\begin{matrix}2 \times 96485.309 [ C / mol ] \times \\ [ \frac{A \cdot s}{C} ] \times \\ \frac{Reformer CH 4 [ I / min ] \times \frac{H {2}_{mol \% drybase}}{\begin{matrix}CH {4}_{mol \% drybase} + \\ {CO}_{mol \% drybase}\end{matrix}}}{22.4 \times [ \frac{273.15 + {T}_{ref}}{273.15} ] [ I / mol ]}\end{matrix}} \qquad [ Equation 2 ]$$

Variable components of the numerator in Equation 2 are the density of current per unit cell of the fuel cell 20, an active cell area of the fuel cell 20, and the number of unit cells in the fuel cell 20. The variable component of the denominator in Equation 2 is the amount of hydrogen supplied to the fuel cell 20, wherein the amount of hydrogen is obtained by multiplying the amount of a city gas Reformer CH4 supplied to the fuel processor 10, by a hydrogen conversion rate H2/(CH4+CO+CO₂) of the Reformer CH4. Here, the hydrogen conversion rate of the city gas is calculated using a mole faction of each component thereof, at a dry base from which hydrogen is removed. Also, T_{ref} is the temperature of the city gas supplied to the fuel cell system of FIG. 1, and is set to be a general room temperature, that is, 20° C.

In order to increase the fuel utilization rate of the fuel cell 20, according to Equation 2, the output current of the fuel cell 20 can be increased, the amount of the city gas is supplied to the fuel cell system can be decreased, and/or the hydrogen conversion rate of the city gas can be decreased. The hydrogen conversion rate is proportional to the reform temperature of the fuel processor 10. The reform temperature of the fuel processor 10 is determined according to the amount of the AOG discharged from the fuel cell 20 and/or the amount of the city gas, both of which are supplied to the burner to heat the reform catalyst. Thus, by decreasing the amount of the AOG discharged from the fuel cell 20 and/or the amount of the city gas supplied to the burner, the fuel utilization rate of the fuel cell 20 may be increased.

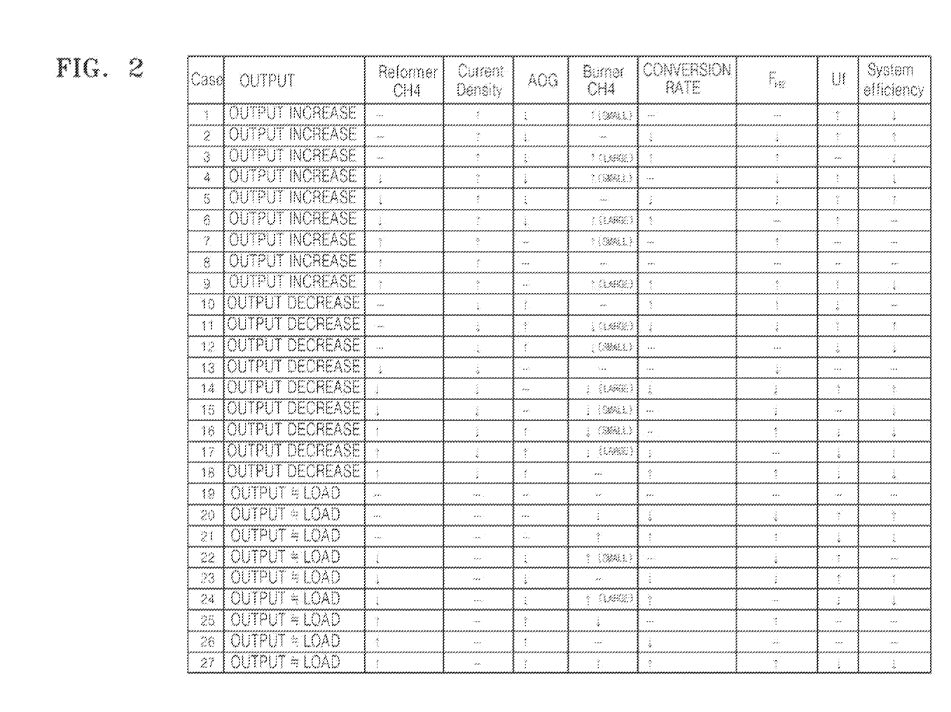

FIG. 2 is a diagram of various control examples of the fuel cell system of FIG. 1. Referring to FIG. 2, 27 control examples of the fuel cell system, and an increase or a decrease of the fuel utilization rate of the fuel cell 20, with respect to each of the 27 control examples, and an increase or a decrease of an efficiency of the fuel cell system, are exhibited. From among factors exhibited in FIG. 2, the amount of the city gas (Reformer CH4) supplied for the reform reaction, the density of current per unit cell of the fuel cell 20, and the amount of the city gas (Burner CH4) supplied to the burner, indicate factors controlled by the controller 40. The amount of the AOG discharged from the fuel cell 20, the hydrogen conversion rate in the fuel processor 10, and an amount of a reformed gas F_{H2} are determined by the factors that are controlled by the controller 40.

Assuming that the fuel cell system of FIG. 1 uses the fuel cell 20 to generate a constant voltage, in order to control the power output of the power converter 30, the controller 40 controls a current output from each unit cell of the fuel cell 20, using the power converter 30. However, it will be understood by one of ordinary skill in the art that the controller 40 may control a voltage output from each unit cell using the power converter 30, so as to control the power output of the power converter 30, assuming that the fuel cell system of FIG. 1 is configured to output a constant current from the fuel cell 20.

In cases 2, 5, 11, 14, 20, and 23, the efficiency of the fuel cell system increases. In case 2, the output of the fuel cell system, that is, the power output of the power converter 30, increases. In order to increase the efficiency of the fuel cell system, and the fuel utilization rate of the fuel cell 20, the controller 40 fixes the amount of city gas reformed by the fuel processor 10 and the amount of city gas supplied to the burner, and increases the density of the current output from each cell of the fuel cell 20 to the power converter 30. Thus, the controller 40 increases the power output of the power converter 30.

In this case, by increasing the density of the current output from each unit cell of the fuel cell 20, the electrochemical reaction rate of the fuel cell 20 is enhanced. However, since the amount of city gas reformed by the fuel processor 10 is fixed, the amount of AOG discharged from the fuel cell 20 is decreased. Since the amount of AOG discharged is decreased, while the amount of the city gas supplied to the burner is fixed, the reform temperature of the fuel processor 10 is reduced. Accordingly, the hydrogen conversion rate of the fuel processor 10 is reduced, and thus, the production of the reformed gas is reduced. Since the density of the current output from each cell of the fuel cell 20 is increased, and the hydrogen conversion rate of the city gas is reduced, the fuel utilization rate corresponding to Equation 2 increases. Thus, the efficiency of the fuel cell system also increases.

In case 5, the output of the fuel cell system, that is, the power output of the power converter 30, increases. In order to increase the efficiency of the fuel cell system, and the fuel utilization rate of the fuel cell 20, the controller 40 fixes the amount of city gas supplied to the burner, decreases the amount of the city gas reformed by the fuel processor 10, and increases the density of the current output from each unit cell to the power converter 30. Thus, the controller 40 increases the power output of the power converter 30. In this case, by increasing the density of the current output from each unit cell, the electrochemical reaction rate of the fuel cell is increased. However, since the amount of city gas reformed by the fuel processor 10 is decreased, the amount of AOG discharged from the fuel cell 20 is decreased. Since the amount of AOG is decreased, while the supply city gas for the burner is fixed, the reform temperature of the fuel processor 10 is reduced. Accordingly, the hydrogen conversion rate of the fuel processor 10 is reduced, and thus, the amount of the reformed gas produced is reduced. Since the density of the current output from each unit cell of the fuel cell 20 is increased, and the hydrogen conversion rate is reduced, the fuel utilization rate corresponding to Equation 2 increases. Thus the efficiency of the fuel cell system also increases.

In case 11, the output of the fuel cell system, that is, the power output of the power converter 30, decreases. In order to increase the efficiency of the fuel cell system, and the fuel utilization rate of the fuel cell 20, the controller 40 fixes the amount of city gas supplied to the fuel processor 10, significantly decreases the amount of city gas supplied to the burner, and decreases the density of the current output from each unit cell to the power converter 30. Thus, the controller 40 decreases the power output of the power converter 30.

In this case, by decreasing the density of the current output from each unit cell, the electrochemical reaction rate of the fuel cell 20 is reduced. Since the amount of city gas reformed in the fuel processor 10 is fixed, the amount of AOG discharged is increased. However, since the amount of city gas supplied to the burner is significantly reduced, as compared to the increase in the amount of the AOG, the reform temperature of the fuel processor 10 is reduced. Accordingly, the hydrogen conversion rate of the fuel processor 10 is reduced. Thus the amount of the reformed gas produced is decreased. In this manner, the density of the current output from each unit cell of the fuel cell 20 is decreased. However, since the hydrogen conversion rate of the fuel processor 10 is significantly reduced, as compared to the decrease in the density of the current output of the fuel cell 20. Thus, the fuel utilization rate corresponding to Equation 2 increases and the efficiency of the fuel cell system also increases.

In case 14, the output of the fuel cell system, that is, the power output of the power converter 30, decreases. In order to increase the efficiency of the fuel cell system, and the fuel utilization rate of the fuel cell 20, the controller 40 decreases the amount of city gas reformed in of the fuel processor 10, significantly decreases the amount of the city gas supplied to the burner, and decreases the density of the current output from each unit cell of the fuel cell 20 to the power converter 30. Thus, the controller 40 decreases the power output of the power converter 30.

By decreasing the density of the current output of each unit cell, the electrochemical reaction rate of the fuel cell 20 is reduced. However, since the amount of city gas reformed in the fuel processor 10 is fixed, the amount of AOG discharged from the fuel cell 20 is almost unchanged.

However, since the amount of city gas supplied to the burner is significantly reduced, the reform temperature of the fuel processor 10 is reduced, and the hydrogen conversion rate of the fuel processor 10 is reduced. Thus, the production of the reformed gas is decreased. In this manner, the density of the current output from each unit cell of the fuel cell 20 is decreased. However, since the hydrogen conversion rate of the fuel processor 10 is significantly reduced, as compared to the reduction in the density of the current output of the fuel cell 20, the fuel utilization rate corresponding to Equation 2 increases. Thus, the efficiency of the fuel cell system also increases.

In case 20, the output of the fuel cell system, that is, the power output of the power converter 30, is maintained within an approximate range corresponding to the load 50. In order to increase the efficiency of the fuel cell system and the fuel utilization rate of the fuel cell 20, the controller 40 fixes the amount of city gas reformed in the fuel processor 10, decreases the amount of city gas supplied to the burner, and fixes the density of the current output from each unit cell of the fuel cell 20 to the power converter 30. Thus, the controller 40 fixes the power output of the power converter 30.

Since the amount of city gas reformed by the fuel processor 10 is fixed, and the density of the current output from each unit cell of the fuel cell 20 is fixed, the amount of AOG discharged from the fuel cell 20 is almost unchanged. However, since the amount of city gas supplied to the burner is reduced, the reform temperature of the fuel processor 10 is reduced, and the hydrogen conversion rate of the fuel processor 10 is reduced. Thus, the production of the reformed gas is decreased. In this manner, the density of the current output from each unit cell is fixed, the hydrogen conversion rate of the fuel processor 10 is reduced, and the fuel utilization rate corresponding to Equation 2 increases. Thus, the efficiency of the fuel cell system also increases.

In case 23, the output of the fuel cell system, that is, the power output of the power converter 30, is maintained within an approximate range corresponding to the load 50. In order to increase the efficiency of the fuel cell system and the fuel utilization rate of the fuel cell 20, the controller 40 decreases the amount of city gas reformed by the fuel processor 10, fixes the amount of city gas supplied to the burner, and fixes the density of the current output from each unit cell of the fuel cell 20 to the power converter 30. Thus, the controller 40 fixes the power output of the power converter 30.

Since the amount of city gas reformed by the fuel processor 10 is decreased, while the density of the current output from each unit cell is fixed, the amount of AOG discharged from the fuel cell 20 is decreased. However, since the amount of AOG is decreased, while the amount of city gas supplied to the burner is fixed, the reform temperature of the fuel processor 10 is reduced, and then the hydrogen conversion rate of the city gas in the fuel processor 10 is reduced and thus the amount of the reformed gas containing sufficient hydrogen is decreased. In this manner, the density of the current output from each cell of the fuel cell 20 is fixed and the hydrogen conversion rate of the city gas in the fuel processor 10 is reduced, the fuel utilization rate corresponding to Equation 2 increases and thus the efficiency of the fuel cell system also increases.

In other cases where the efficiency of the fuel cell system decreases, a phenomenon contrary to aforementioned phenomena may occur, and thus, a detailed description thereof is omitted. In cases 4 and 9, the fuel utilization rate of the fuel cell 20 increases. However, since the amount of city gas reformed by the fuel processor is decreased, or the amount of city gas supplied to the burner is increased, in cases 4 and 9, the efficiency of the fuel cell system is decreased.

When the load 50 is sharply changed and the temperature of the reform catalyst is decreased, to efficiently drive of the fuel cell system as described above, the temperature of the reform catalyst may not immediately increase when the supply of city gas for the burner is increased. Thus, the following capability for the load 50 may be reduced. Thus, the controller 40 controls the fuel cell system of FIG. 1, according to one of two control modes. In particular, the control modes include a load following mode that increases the load following capability, and a high efficiency mode that increases the efficiency of the fuel cell system.

According to the related art, the load following capability is given priority, and thus, a significant amount of fuel is wasted in such a system. However, according to the present embodiments, the load following mode or the high efficiency mode is selected, according to the condition of the load 50, so that it is possible to achieve both the load following capability and high efficiency of the fuel cell system of FIG. 1.

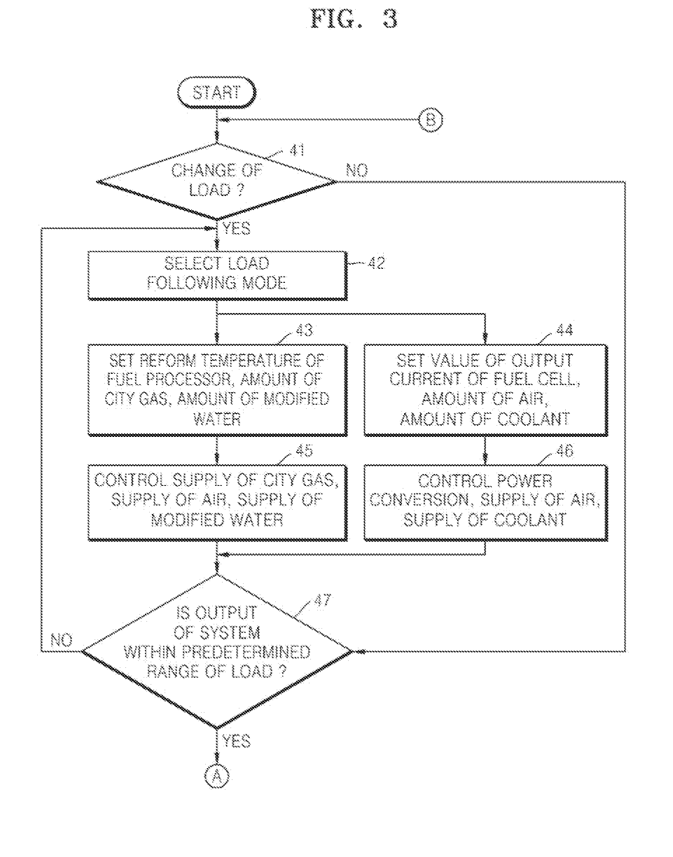

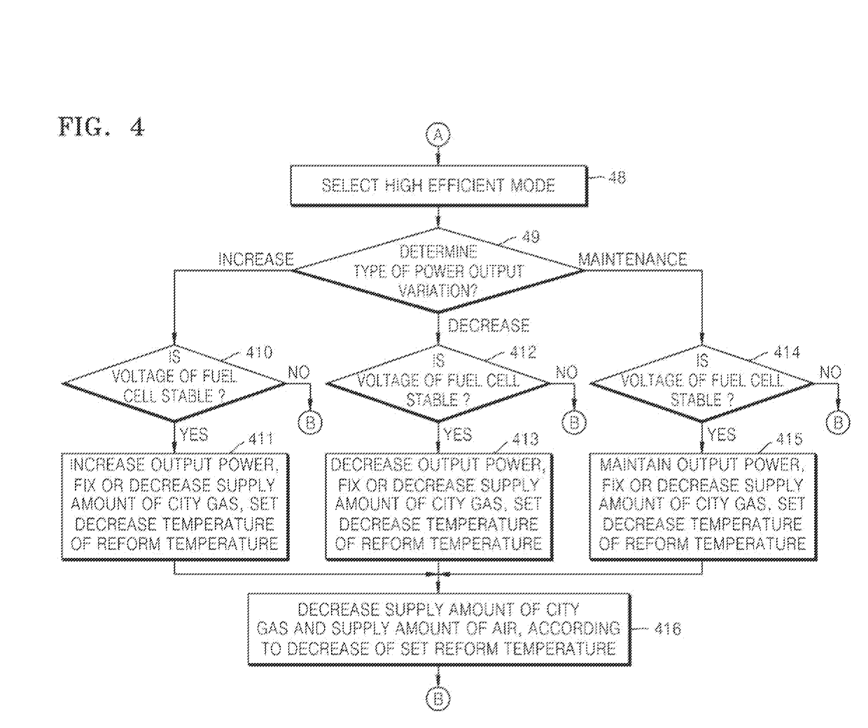

FIGS. 3 and 4 are flowcharts of a control method performed by the controller 40 of FIG. 1, according to an exemplary embodiment of the present invention. Referring to FIGS. 3 and 4, the method of controlling the fuel cell system includes sequentially implemented operations that are processed by the controller 40 of FIG. 1. Thus, a detailed description of the controller 40 is omitted.

In operation 41, the controller 40 determines whether a variation of the load 50 occurs. For example, when the fuel cell system of FIG. 1 is used to supply power to electronic devices in a house, the load 50 may vary according to power consumed by the electronic devices. The variation of the load 50 may be detected by measuring a demand power value of the load 50, that is, a value of the power flowing into the load 50. In more detail, the controller 40 detects the variation of the load 50, when a present value of the load 50 deviates from a rated range of a previous value of the load 50. The present value of the load 50 is calculated by multiplying a present current value measured by a current measurer 35, by a present voltage value measured by a voltage measurer 36. For example, the rated range of the load 50 may be any change in the load of more than +/−5%. If the previous value of the load 50 is 1 kilo watt (Kw), the controller 40 detects the variation of the load 50 when the present value of the load 50 deviates by +/−50 W. When the variation of the load 50 is detected, the method proceeds to operation 42, otherwise the method proceeds to operation 47.

In operation 42, in order to minimize a response time with respect to the variation of the load 50, the controller 40 selects the load following mode having the preference for the load following capability from among the control modes of the fuel cell system of FIG. 1. The load following mode indicates the mode for setting a reform temperature of the fuel processor 10, so as to maintain a constant conversion rate in all loads, by the fuel processor 10, so as to maintain the constant conversion rate in the fuel processor 10, a lookup table is referred to. The lookup table includes temperature values corresponding to various loads, which are determined according to experimental data.

In operation 43, according to the load following mode selected in operation 42, the controller 40 sets a reform temperature of the fuel processor 10, and set amounts of city gas and water to be supplied to the fuel processor 10. The reform temperature and the amounts of city gas and water correspond to the load 50. For example, the controller 40 may determine the reform temperature in the fuel processor 10 with respect to the present value of the load 50, and sets the amounts of city gas and the water to be supplied to the fuel processor 10, by referring to a lookup table, in which reform temperatures in the fuel processor 10 and amounts of city gas and water are recorded for various load values.

In operation 44, according to the load following mode selected in operation 42, the controller 40 sets an output current of the fuel cell 20, and amounts of air and coolant to be supplied to the fuel cell 20, all of which correspond to the load 50. For example, the controller 40 may set the output current of the fuel cell 20, and the amounts of air and coolant, with respect to the present value of the load 50, by referring to a lookup table, in which the value of the output current of the fuel cell 20, and the amount of the air and the coolant to be supplied to the fuel cell 20 are recorded for various load values.

In operation 45, the controller 40 controls the amounts of city gas and air supplied to a burner of the fuel processor 10, such that the reform catalyst of the fuel processor 10 reaches the reform temperature set in operation 42. In particular, the controller controls the electronic valve 13, the city gas pump 12, the electronic valve 15, and the air pump 16, in operation 45. Also, the controller 40 controls the amount of city gas supplied to the fuel processor 10, in accordance with the set in operation 43, by controlling the city gas pump 12 and the electronic valve 14. Also, the controller 40 controls the water pump 11, in accordance with the amount of water set in operation 43.

In operation 46, the controller 40 controls the power converter 30, so as to output the output current amount set in operation 44. Assuming that the fuel cell system of FIG. 1 is set for generating and outputting a constant voltage via the fuel cell 20, in order to control the output of the power converter 30, the controller 40 controls the current output from each unit cell to the power converter 30. Also, the controller 40 controls the amount of air supplied to the fuel cell 20, by controlling an air pump 31, in accordance with the amount of the air set in operation 44. Also, the controller 40 controls the amount of coolant supplied to the fuel cell 20, by controlling a coolant pump 32, in accordance with the amount of the coolant set in operation 43.

In operation 47, the controller 40 detects whether the power output of the fuel cell system of FIG. 1, that is, the power output of the power converter 30, is within a predetermined range of the load 50. The power output of the power converter 30 is obtained by multiplying the present current value measured by the current measurer 35, by the present voltage value measured by the voltage measurer 36. For example, the predetermined range of the load 50 may cover a variation range within +/−2% of the load 50. If the load 50 is 1 Kw, the controller 40 detects that the power output of the power converter 30 is in the predetermined range of the load 50, when the power output of the power converter 30 is within about 1 Kw+/−20 w. When the power output of the fuel cell system is within 2% of the load 50, the method proceeds to operation 48, otherwise the method returns to operation 42. When the power output of the power converter 30 exceeds +/−2% of the load 50, the load following mode is maintained, otherwise the controller 40 selects the high efficiency mode.

In operation 48, the controller 40 selects the high efficiency mode having the preference for the efficiency of the fuel cell system from among the control modes of the fuel cell system of FIG. 1. The high efficiency mode indicates a mode for setting the reform temperature of the fuel processor 10, so as to maintain a minimum reform conversation rate for a particular load, to maximize the efficiency of the fuel cell system, to the extent that the fuel cell 20 is not negatively affected.

In operation 49, the controller 40 detects the power output of the fuel cell system of FIG. 1, that is, the controller 40 determines the type of variation of the power output of the power converter 30. In more detail, the controller 40 may periodically measure the power output of the power converter 30, by using the current measurer 35 and the voltage measurer 36, and may detect the variation type by referring to changes in the measured values of the power output. When the variation indicates an increase of the power output of the fuel cell system, the method proceeds to operation 410, when the variation indicates a decrease of the power output of the fuel cell system, the method proceeds to operation 411, and when the variation indicates that the power output of the fuel cell system is maintained (stable) within an approximate range of the load 50, the method proceeds to operation 412.

In operation 410, the controller 40 determines whether the output voltage of the fuel cell 20 is in a stable, by detecting an amount of variation of the output voltage of the fuel cell 20. In more detail, the controller 40 periodically measures the output voltage of the fuel cell 20, using a voltage measurer 34, and calculates a moving average of the output voltage. Based on the calculated moving average, the controller 40 calculates a standard deviation of the measured output voltages. If the standard deviation is less than a threshold value, the controller 40 determines that the output voltage is stable. If the standard deviation is greater than the threshold value, the controller 40 determines that the output voltage of the fuel cell 20 is not stable. When the output voltage of the fuel cell 20 is stable, the method proceeds to operation 410, otherwise the method returns to operation 41.

In the case where a variation of the output voltage of the fuel cell 20 is severe in the system for generating and outputting a constant voltage via the fuel cell 20, there is a need to ensure the stability hydrogen conversion rate, so as not to affect operations of the fuel cell 20, rather than to minimally maintain the reform temperature of the fuel processor 10, that is, the constant conversion rate. According to the present embodiment, when the power output of the fuel cell system is stable, the efficiency of the fuel cell system may be improved.

In operation 411, in correspondence to cases 2 and 5 of FIG. 2, the controller 40 fixes or decreases the amount of city gas reformed by the fuel processor 10, sets a lower temperature of the reform temperature of the fuel processor, and increases the power output of the fuel cell system. That is, the power output of the power converter 30 is increased, so as to increase the fuel utilization rate corresponding to Equation 2. In general, an increase of the power output of the fuel cell system corresponds to an increase of the load 50, so that to increase the power output of the fuel cell system corresponds to (follows) the load 50.

In more detail, the controller 40 increases the fuel utilization rate by a predetermined amount, e.g., by about 0.1%, and controls the power converter 30, thereby increasing the output voltage of the fuel cell 20, by a predetermined unit, within a tolerance range. For example, the tolerance range may be a variation of +/−2% of the load 50, and the predetermined unit may be about 0.2% of the load 50. For example, when the load 50 is 1 Kw, the tolerance range may be in a range of about 1 Kw+/−20 w, and the predetermined unit may be about 2 w. In this manner, when the fuel utilization rate and the output voltage of the fuel cell 20 are determined, the amount of city gas, and the constant conversion rate corresponding to the reform temperature of the fuel processor 10, may be determined by using Equation 2. The controller 40 controls the amount of city gas to be supplied to the fuel processor 10, in accordance with the set amount, by controlling the city gas pump 12 and the electronic valve 14. Also, the controller 40 controls the amount of water, by controlling the water pump 11, in accordance with the amount of city gas.

In operation 412, the controller 40 determines whether the output voltage of the fuel cell 20 is stable, by detecting the variation of the output voltage of the fuel cell 20. Operation 412 is performed in a similar manner as operation 410.

In operation 413, in correspondence to cases 11 and 14 of FIG. 2, the controller 40 fixes or decreases the amount of city gas reformed by the fuel processor 10, sets a decrease temperature of the reform temperature of the fuel processor 10, and decreases the power output of the fuel cell system. That is, the power output of the power converter 30 is decreased, so as to increase the fuel utilization rate corresponding to Equation 2. In general, a decrease of the power output of the fuel cell system refers to a decrease in the load 50, so that the power output of the fuel cell system decreases to follow the load 50.

In more detail, the controller 40 increases the fuel utilization rate by a predetermined unit, e.g., by about 0.1%, and controls the power converter 30, thereby decreasing the output voltage of the fuel cell 20, by a predetermined unit, within a tolerance range. For example, the tolerance range may be a load variation of +/−2%, and the predetermined unit may be about 0.2% of the load 50. For example, when the load 50 is 1 Kw, the tolerance range may be about 1 Kw+/−20 w, and the predetermined unit may be about 2 w. In this manner, when the fuel utilization rate and the output voltage of the fuel cell 20 are determined, the amount of city gas, and the constant conversion rate corresponding to the reform temperature of the fuel processor 10, may be determined by using Equation 2. The controller 40 controls the amount of the city gas in accordance with the set amount, by controlling the city gas pump 12 and the electronic valve 14. Also, the controller 40 controls the amount of the water, by controlling the water pump 11, in accordance with the amount of city gas.

In operation 414, the controller 40 determines whether the output voltage of the fuel cell 20 is stable, by detecting the variation of the output voltage of the fuel cell 20. Operation 414 is performed in a similar manner as that of operation 410.

In operation 415, in correspondence to cases 20 and 23 of FIG. 2, the controller 40 fixes or decreases the amount of city gas reformed by the fuel processor 10, sets a decrease temperature of the reform temperature of the fuel processor 10, and fixes the power output of the fuel cell system. That is, the controller fixes the power output of the power converter 30, so as to increase the fuel utilization rate. In general, the fact that the power output of the fuel cell system is in an approximate range of the load 50 refers to the load 50 being nearly unchanged, so that the power output of the fuel cell system corresponds to the load 50.

In more detail, the controller 40 increases the fuel utilization rate corresponding to Equation 2 by a predetermined unit, e.g., by about 0.1%, and controls the power converter 30, thereby maintaining the output voltage of the fuel cell 20. In this manner, when the fuel utilization rate and the output voltage of the fuel cell 20 are determined, the amount of the city gas, and the constant conversion rate corresponding to the reform temperature of the fuel processor 10 may be determined using Equation 2. The controller 40 controls the amount of city gas in accordance with the set amount, by controlling the city gas pump 12 and the electronic valve 14. Also, the controller 40 controls the amount of water to be supplied to the fuel processor 10, by controlling the water pump 11 in accordance with the amount of city gas.

In operation 416, as the temperature of the reform catalyst is decreased according to the reform temperature set in operation 411, operation 413, or operation 415, by controlling the electronic valve 13, the city gas pump 12, the electronic valve 15, and the air pump 16, the controller 40 decreases the amount of city gas supplied to the burner and the amount of air supplied to the fuel processor 10. Afterwards, the method proceeds to operation 41.

According to the one or more embodiments, the efficiency of the fuel cell system may be improved, by changing only a control algorithm of the fuel cell system, without changing hardware of the fuel cell system.

The controller 40 may be embodied as an array of logic gates, or may be embodied as combination of a general-use microprocessor and a recording medium having recorded thereon a program to be executed in the general-use microprocessor. In case of the combination, the operations described with reference to FIGS. 3 and 5 may be written as computer programs and may be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), etc.

Although a few exemplary embodiments of the present invention have been shown and described, it would be appreciated by those skilled in the art that changes may be made in these exemplary embodiments, without departing from the principles and spirit of the invention, the scope of which is defined in the claims and their equivalents.

What is claimed is:

1. A method of controlling a fuel cell system that includes a fuel processor to reform a fuel, and a fuel cell to electrochemically react the reformed fuel to produce power, the method comprising:
detecting a variation of the power output of the fuel cell system; and
controlling the power output of the fuel cell system and an amount of the fuel supplied to the fuel processor, so as to increase the fuel utilization rate of the fuel cell, according to the variation of the power output.

2. The method of claim 1, wherein the controlling further comprises:
reducing a set reform temperature of the fuel processor; and
decreasing an amount of the fuel that is supplied to a burner of the fuel processor, to reduce the actual reform temperature of the fuel processor to the set reform temperature, so as to increase the fuel utilization rate of the fuel cell.

3. The method of claim 2, wherein, when the variation of the power output is an increase of the power output, the controlling comprises increasing the power output of the fuel cell system, and fixing or decreasing the amount of the fuel reformed by the fuel processor.

4. The method of claim 2, wherein, when the variation of the power output is a decrease of the power output, the controlling comprises decreasing the power output of the fuel cell system, and fixing or decreasing the amount of the fuel reformed by the fuel processor.

5. The method of claim 2, wherein, when the variation of the power output is within an approximate range of a load, the controlling comprises fixing the power output of the fuel cell system, and fixing or decreasing the amount of the fuel reformed by the fuel processor.

6. The method of claim 1, wherein, when an output voltage of the fuel cell is generally stable, the controlling comprises controlling the power output of the fuel cell system, and the amount of the reformed fuel supplied to the fuel cell system.

7. The method of claim 6, further comprising determining whether the output voltage of the fuel cell is generally stable, based on a moving average of the output voltage of the fuel cell, over a predetermined time period.

8. The method of claim 1, further comprising selecting a control mode of the fuel cell system, according to a type of variation in a load connected to the fuel cell system, the control mode selected from among:
a high efficiency mode that improves the efficiency of the fuel cell system; and
a load following mode that improves the load following capability of the fuel cell system.

9. The method of claim 8, wherein the selecting comprises selecting the high efficiency mode, when the load is stable, and the controlling comprises controlling the power output of the fuel cell system and the amount of the reformed fuel supplied to the fuel cell system, so as to increase the fuel utilization rate of the fuel cell.

10. The method of claim 9, wherein the selecting comprises selecting the load following mode, when the load is not stable, and the controlling comprises controlling the power output of the fuel cell system and the amount of the reformed fuel supplied to the fuel cell system, so as to increase the load following capability of the fuel cell system.

11. A computer readable recording medium having recorded thereon a program for executing the method of claim 1, using a computer.

12. A fuel cell system comprising:
a fuel cell to generate power using a fuel;
a power converter to convert the generated power generated into a power suitable for output to a load; and
a controller to control the power converter and an amount of the fuel supplied to the fuel cell, so as to increase a fuel utilization rate of the fuel cell, according to a type of variation of the power output from the power converter.

13. The fuel cell system of claim 12, further comprising a fuel processor to reform the fuel, and
wherein the controller decreases the reform temperature of the fuel processor, so as to increase the fuel utilization rate of the fuel cell.

14. The fuel cell system of claim 13, wherein the controller decreases the reform temperature, by decreasing the amount of the fuel that is supplied to a burner of the fuel processor.
